(19) United States
(12) Patent Application Publication
(10) Pub. No.: US 2013/0227225 A1
(43) Pub. Date: Aug. 29, 2013

(54) METHOD AND APPARATUS FOR DETERMINING USER CHARACTERISTICS BASED ON USE

(71) Applicants: Ian Justin Oliver, Soderkulla (FI); Sini Annukka Vartiainen, Espoo (FI)

(72) Inventors: Ian Justin Oliver, Soderkulla (FI); Sini Annukka Vartiainen, Espoo (FI)

(73) Assignee: Nokia Corporation, Espoo (FI)

(21) Appl. No.: 13/406,004

(22) Filed: Feb. 27, 2012

(51) Int. Cl. G06F 12/00

(52) U.S. Cl. 711/154; 711/E12.001

(57) ABSTRACT

An approach is provided for determining user characteristics based on use. The characteristic platform causes, at least in part, a storage of data associated with at least one use of one or more services, one or more applications, or a combination thereof in at least one buffer, wherein the data is associated with at least one user of the one or more services, the one or more applications, or a combination thereof. Next, the characteristic platform processes and/or facilitates a processing of the data to determine one or more characteristics of the at least one user. Then, the characteristic platform determines at least one disposition of the data in the at least one buffer based, at least in part, on the one or more characteristics.

### BACKGROUND

Service providers and device manufacturers (e.g., wireless, cellular, etc.) are continually challenged to deliver value and convenience to consumers by, for example, providing compelling network services. One area of interest has been the development of services and technologies related to online safety for children. For example, services and technologies have been developed to make the Internet a safety place for children and to satisfy the requirements of child protection laws, such as laws that prohibit the collection of use data, personal data, etc., associated with children, laws that proscribe offering of adult services and content to children, etc. However, children often lie about, or are unwilling to provide, their age when signing up or registering for services, applications, etc. As such, services and technologies designed to protect children are frequently ineffective.

### SOME EXAMPLE EMBODIMENTS

Therefore, there is a need for an approach for determining user characteristics based on use.

According to one embodiment, a method comprises causing, at least in part, a storage of data associated with at least one use of one or more services, one or more applications, or a combination thereof in at least one buffer, wherein the data is associated with at least one user of the one or more services, the one or more applications, or a combination thereof. The method also comprises processing and/or facilitating a processing of the data to determine one or more characteristics of the at least one user. The method further comprises determining at least one disposition of the data in the at least one buffer based, at least in part, on the one or more characteristics.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, a storage of data associated with at least one use of one or more services, one or more applications, or a combination thereof in at least one buffer, wherein the data is associated with at least one user of the one or more services, the one or more applications, or a combination thereof. The apparatus is also caused to process and/or facilitate a processing of the data to determine one or more characteristics of the at least one user. The apparatus is further caused to determine at least one disposition of the data in the at least one buffer based, at least in part, on the one or more characteristics.

According to another embodiment, a computer-readable storage medium carries one or more sequences of one or more instructions which, when executed by one or more processors, cause, at least in part, an apparatus to cause, at least in part, a storage of data associated with at least one use of one or more services, one or more applications, or a combination thereof in at least one buffer, wherein the data is associated with at least one user of the one or more services, the one or more applications, or a combination thereof. The apparatus is also caused to process and/or facilitate a processing of the data to determine one or more characteristics of the at least one user. The apparatus is further caused to determine at least one disposition of the data in the at least one buffer based, at least in part, on the one or more characteristics.

According to another embodiment, an apparatus comprises means for causing, at least in part, a storage of data associated with at least one use of one or more services, one or more applications, or a combination thereof in at least one buffer, wherein the data is associated with at least one user of the one or more services, the one or more applications, or a combination thereof. The apparatus also comprises means for processing and/or facilitating a processing of the data to determine one or more characteristics of the at least one user. The apparatus further comprises means for determine at least one disposition of the data in the at least one buffer based, at least in part, on the one or more characteristics.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides. For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining user characteristics based on use, according to one embodiment;

FIG. 2 is a diagram of the components of a characteristic platform, according to one embodiment;

FIG. 3A is a flowchart of a process for determining user characteristics based on use, according to one embodiment;

FIG. 3B is a diagram of a data flow based on an age associated with data, according to one embodiment;

FIG. 4 is a flowchart of a process for initiating actions based on a determination that information associated with a user request does not enable accurate and/or certain determination of characteristics, according to one embodiment;

FIG. 5 is diagram of a use case for determining user characteristics, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for determining user characteristics based on use are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

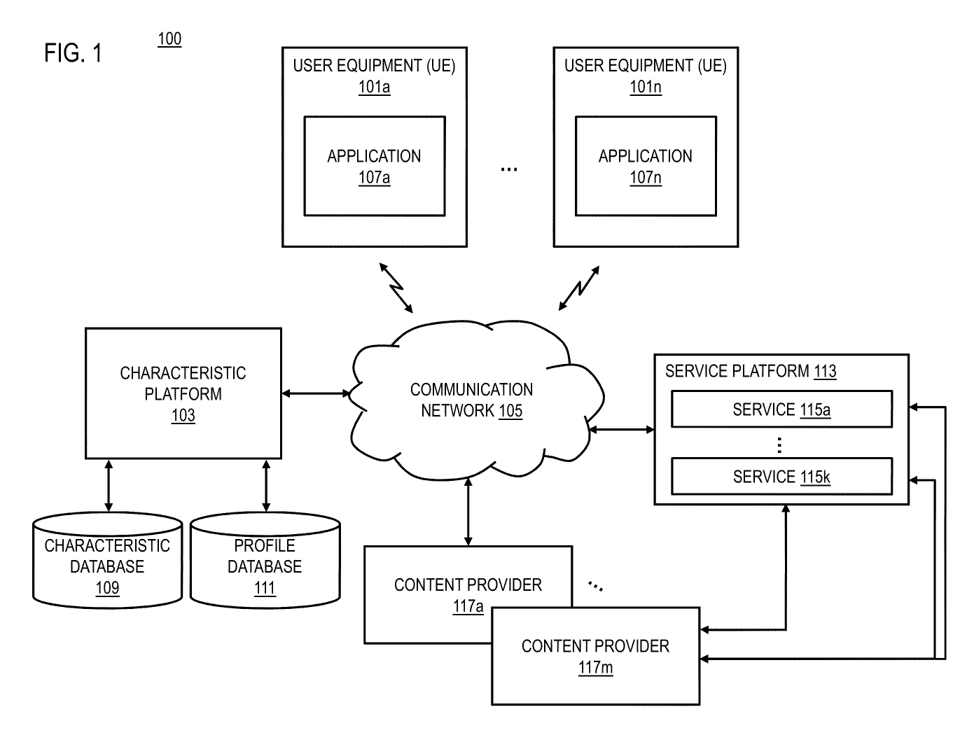

FIG. 1 is a diagram of a system capable of determining user characteristics based on use, according to one embodiment. As discussed, services and technologies must comply with child protection laws of the various jurisdictions which they serve. Child protection laws (e.g., as contained in Children's Online Privacy Protection Act (COPPA), European Union Data Protection Directive, etc.) may, for instance, prohibit the collection of usage and personal data associated with children, proscribe the offering of adult services and content to children, and require a number of checks to be made upon a person's age when accessing certain kinds of online services, such as social networks, chats, etc. In addition, to satisfy parents and other consumers, companies may mandate that greater restrictions on data collection, service and content offerings, etc., for those users who identify themselves as children. As an example, a social networking service may request that potential users provide their birthdates during registration to become members of the associated social network. Based on the registration, users with birthdates indicating that they are under a particular threshold age may be denied member access until the parents of those users provide explicit parental consent. Alternatively, the service may block collection of data associated with those users and grant those users limited access to social networking features. Nonetheless, as mentioned, children are often lie about, or are unwilling to provide, their age when signing up or registering for services, applications, etc. As a result, these checks are frequently ineffective. Although it is possible for these services to require potential users to provide other reliable information, such as driver's licenses information, credit card information, etc., to verify their age, these strict and inconvenient requirements may discourage age-appropriate consumers from signing up for such services.

To address this problem, a system 100 of FIG. 1 introduces the capability to determine user characteristics based on use, for instance, to make the Internet a safer place for children. Specifically, the system 100 may store data associated with a use, and a user, of a service and/or an application in a buffer; process the data in the buffer to determine characteristics of the user (e.g., an age of the user); and determine a disposition of the data in the buffer based on the characteristics. By way of example, the disposition may include destruction of the data, a processing of the data by the one or more services and/or the one or more applications, etc. It is noted that although various embodiments are described with respect to age, it is contemplated that the approach described herein may be used with any other user characteristics (e.g., mental conditions, physical traits, personality types, etc.).

In one scenario, a user may utilize a social networking application on the user's device to interact with a social networking service. As such, the user's usage data associated with the application and/or the service may be collected and stored in a buffer separate (e.g., logically, physically, etc.) from memory that is accessible by “traditional” analytics (e.g., determining personal preferences based on usage data, determining buying habits based on usage data, etc., for advertising purposes). The collected data associated with the user in the buffer may, for instance, include the location of the user's device when the application and/or the service is being utilized by the user, the time associated with the use of the application and/or the service, the content being consumed by the user while using the application and/or the service, etc. While the data is in the buffer, information associated with the location of the use, the time of the use, and the consumed content during the use, etc., may be processed to determine the user's age range (e.g., child, mature teen, adult, etc., or 8-13, 13-17, etc.). By way of example, information associated with the location of the use (e.g., a cell identification (ID) data, global positioning system (GPS) data, etc.) may be compared against a body of known data of locations frequented by children (e.g., schools, youth clubs, etc.). The information associated with the time of the use may be compared against a body of known data denoting when children are more likely to be present around the location of use (e.g., children are very likely to be around school during school hours). The information associated with the consumed content may be compared with a body of known data indicating the type of content that are typically consumed by various age groups (e.g., free form jazz is more likely to be listened to by adults than children, while the latest pop music is more likely to be listened to by children). Subsequently, the determination of the user's age range may be utilized to decide what to do with the data in the buffer.

It is noted that as a user continues to use applications and/or services, the user characteristic analytics can run continuously. If, for instance, the user is determined to be a child, “traditional” analytics on collected data associated with the user may be blocked. In some embodiments, the window of time that the characteristic analytics takes to run can be used to stall or delay the processing of the raw collected data by “traditional” analytics to prevent the data from being accidentally analyzed (e.g., by “traditional” analytics) if, for instance, the determination of the user's age switches from “adult” to “child.” For illustrative purposes of how age may be calculated, Table 1 is provided below. It is noted, however, that the list in Table 1 is not an exhaustive list, and is intended only to given an impression of what can be utilized.

TABLE 1

| | |
|---|---|
| (1) | By analyzing location data (e.g., cell ID) against a body of known data of locations |
| | frequented by children (e.g., schools, youth clubs, etc.); |
| (2) | By analyzing timing data against a body of known data denoting when children are |
| | more likely to be present around certain locations (e.g., school hours); |
| (3) | By correlating timing and location data as described above; |
| (4) | By analyzing music, video, or other media preferences against a known body of popular |
| | or contemporary music (e.g., free form jazz is more likely to be listened to by adults |
| | than children, while the latest pop music is more likely to be listened to by children); |
| (5) | By analyzing consumed media channels (e.g., TV stations, radio stations, etc.); |
| (6) | By analyzing consumed television or radio programs and their timing (e.g., children's |
| | programs vs. news); |
| (7) | By correlating service usage times against TV, radio, and other media schedules; |
| (8) | By analyzing the age distributions of friends/family in social networks and contact |
| | listings; |
| (9) | By analyzing the types of relationships in social networks and contact listings (e.g., if |
| | many relationships are listed as co-worker relationships, then this implies an adult); |
| (10) | By analyzing the physical location of people in social networks, contact listings, etc. |
| | (e.g., if many of the related people are geographically local then this implies a child |
| | rather than an adult); |
| (11) | By analyzing membership to certain clubs, existence of a driver's license, etc.; and |
| (12) | By analyzing for given language usage in an email, short message service (SMS) |
| | message, social network chat, etc. (e.g., contemporary or slang language implies a child, |
| | use of certain profane or sexual languages generally implies an adult, etc.). |

As shown in FIG. 1, the system 100 comprises a user equipment (UE) 101 (or multiple UEs 101a-101n) having connectivity to a characteristic platform 103 via a communication network 105. The UE 101 may include or have access to an application 107 (e.g., applications 107a-107n) to enable the UE 101 to interact with, for instance, the characteristic platform 103, which may: (1) cause storage of data associated with a use, and a user, of a service and/or an application; (2) process the data in the buffer to determine characteristics of the user; (3) determine a disposition of the data in the buffer based on the characteristics; (4) cause flagging of the use, the user, and/or an account associated with the user; (5) determine contextual information associated with the user and/or a device associated with the user; (6) cause anonymization on a portion of the data prior to the storage of the data, the processing of the data, and/or the determining of the disposition of the data; (7) determine to enable and/or disable components of the data, the service, the application, and/or devices associated with the user based on the characteristics; or (8) perform other functions.

In various embodiments, the characteristic platform 103 may include or have access to a characteristic database 109 to access or store attributes/features that can be utilized to determine characteristics of users based on their use, contextual data, etc. In addition, the characteristic database 109 may provide rules associated with the characteristics (e.g., actions to be taken with respect to certain characteristics, degree of certainty required for various dispositions, etc.) The characteristic platform 103 may also include or have access to a profile database 111 to access or store usage data (e.g., anonymized usage data marked as child, mature teen, adult, etc., for future characteristic determination purposes), account and/or profile information, etc. Data stored in the characteristic database 109 and the profile database 111 may, for instance, be provided by the UEs 101, a service platform 113, one or more services 115 (or services 115a-115k), one or more content providers 117 (or content providers 117a-117m), and/or other services available over the communication network 105. For example, a certain service 115 may provide initial set of attributes/features that can be utilized to determine characteristics of users based on their use, contextual data, etc. Although the service 115 (or other services) may update the initial set of such attributes/features, the characteristic platform 103 may also augment the attributes/features in the characteristic database 109 by developing new attributes/features based on a self-learning process while processing data from UEs 101 to determine characteristics of users. It is noted that the characteristic platform 103 may be a separate entity of the system 100, a part of the one or more services 115 of the service platform 113, or included within the UE 101 (e.g., as part of the application 107).

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In another embodiment, the characteristic platform 103 may determine a request from the at least one user for initiating the one or more services, the one or more applications, or a combination thereof. The characteristic platform 103 may then process and/or facilitate a processing of the request to determine that the request, information associated with the request, or a combination thereof does not enable determination of the one or more characteristics to a predetermined accuracy, a predetermined certainty, or a combination thereof. In a further embodiment, the characteristic platform 103 may cause, at least in part, an initiation of the storage of the data, the processing of the data, the determining of the at least one disposition, or a combination thereof based, at least in part, on the processing of the request. By way of example, a user may initiate a request for a particular service by registering for the service without providing any information with respect to the user's age (e.g., current age, birthdate, etc.). Thus, when the request is processed and it is determined that the request includes no information with respect to the user's age, the characteristic platform 103 may initiate the storage of the user's usage data associated with the service in a buffer for processing to determine the disposition for the usage data.

It is noted that, in some circumstances, the storage of the data, the processing of the data, and/or the determining of the at least one disposition may still be initiated even if the request includes some information with respect to the one or more characteristics (e.g., the request may include conflicting information with respect to a particular characteristic). For example, the storage of the data, the processing of the data, and/or the determining of the at least one disposition may still be initiated to prevent false reporting by users, for instance, with respect to their age. On the other hand, in certain embodiments, the storage of the data, the processing of the data, and/or the determining of the at least one disposition may be limited to circumstances in which the request includes substantially no information with respect to a particular characteristic in question (e.g., the characteristics are not explicitly provided, data typically used to determine those characteristics are not included in the request, etc.).

In another embodiment, the characteristic platform 103 may cause, at least in part, a flagging of the at least one use, the at least one user, one or more accounts associated with the least one user, or a combination thereof based, at least in part, on the processing of the request. In one scenario, a user may sign up for an account to utilize a gaming application without explicitly providing her age or any other information that is generally used to determine her age. As such, the account may be flagged denoting that the account has no age information. Because the account is flagged, any usage data associated with the account may be stored in the buffer to prevent “traditional” analytics from being performed on the usage data. Depending on the particular age group (e.g., a child, a mature teen, an adult, etc.) determined for the data in the buffer, the data in the buffer may, for instance, be destroyed to prevent release of the data (e.g., if the age group is “child” or “mature teen”), or the data may be transmitted to a service associated with the gaming application for “traditional” analytics (e.g., if the age group is “adult”).

In another embodiment, the characteristic platform 103 may cause, at least in part, a flagging of the at least one use, the at least one user, the one or more accounts, or a combination thereof based, at least in part, on the one or more characteristics. By way of example, the flagging denoting whether a particular account is a child or adult can be accomplished either by tagging the account information and/or by tagging the individual data sets (e.g., portions of the data in the buffer). Tagging of accounts may, for instance, utilize a data field associated with the account to store information about whether the account is a child account or adult account. As such, the data in the buffer can be matched to an account (e.g., when the user is logged in) to determine the age of the user associated with the data. While this approach may require that the analytics system consult the account information, optimization may be provided through caching (e.g., of the account information). Additionally, or alternatively, the individual data sets may be flagged with additional metadata to be stored with each set of data in the buffer. Although it is recognized that this approach may, for instance, increase the complexity of the data structure themselves, tagging of the data sets may enable faster processing during analytics. It is noted that numerous values may be utilized for the tags, such as “adult,” “mature teen,” “child,” etc., as well as other values that may corresponding to various legal statuses of persons in various jurisdictions. Moreover, value such as “unknown” could be used, for instance, to suggest that the data is then suitably anonymized and abstracted before processing.

In another embodiment, the characteristic platform 103 may determine a degree of certainty that the one or more characteristics are associated with the at least one user, wherein the at least one disposition is further based, at least in part, on the degree of certainty. In one use case, the certainty of an age characteristic (e.g., child, mature teen, adult, etc.) can be parameterized such that only decisions with greater than 90% certainty (or some other suitable value) will result in a decision being made, the data (or an account associated with the data) being flagged, etc. If, for instance, it is determined that the degree of certainty is less than 90%, the age analysis may continue until that certainty is reached (e.g., by continuing to store additional usage data associated with the user in the buffer and processing the additional data until the predetermined certainty level is reached). In some circumstances, if, for a given user, the results vary over a given duration of time, then the account or the data may be marked to denote that a characteristic determination for the account, the data, etc., is unreliable, and human intervention may be sought. It is recognized that an individual's age, along with other characteristics of the individual, is subjective with respect to the actual, age of the person, and that the degree of certainty depends upon the quality of the analytics algorithms that compute such characteristics.

In another embodiment, the characteristic platform 103 may determine one or more rules associated with the one or more characteristics, wherein the at least one disposition is further based, at least in part, on the one or more rules. By way of example, if the calculated age of the user corresponds to the criteria of a child, then any analytics performed on the data in the buffer that is associated with the user will be according to all applicable rules regarding children (e.g., in compliance with COPPA). On the other hand, if the calculated age of the user corresponds to the criteria of an adult, then any analytics performed on the data in the buffer that is associated with the user will be according to all applicable rules regarding adults.

In another embodiment, the characteristic platform 103 may determine contextual information associated with the at least one user, at least one device associated with the at least one user, or a combination thereof, wherein the one or more characteristics are further based, at least in part, on the contextual information. As mentioned, the one or more characteristics may be determined in a number of ways (e.g., including analysis based on contextual information as described in Table 1 above). Such contextual information may, for instance, include locations traveled by the user and/or the device, the travel times associated with those locations, media preferences associated with the user and/or the device, the type of relationships associated with the user on social networks, etc. In one scenario, for instance, if a user labels a certain number, or percentage, of his/her social connections on a social network as being in a co-worker relationship with the user, then such contextual information may be used to suggest that the user is an adult (e.g., a working adult).

In another embodiment, the characteristic platform 103 may cause, at least in part, an anonymization of at least a portion of the data prior to the storage of the data, the processing of the data, the determining of the at least one disposition of the of the data, or a combination thereof. By way of example, certain pieces of data may need to be anonymized prior to being processed (e.g., to comply with child protection laws), for instance, even if the data is processed in a buffer that is separated from memory that is accessible by “traditional” analytics. In one use case, personally identifiable information may be stripped from the usage data before the usage data is transmitted to the characteristic platform 103 for storage and processing. It is recognized that it may be more difficult to determine a user's age with a high degree of certainty using only anonymized data, as compared with non-anonymized data. As such, the anonymization of the data may be performed, for instance, until it can be determined to at least a reasonable degree of certainty (e.g., 40% certainty rather than 90% certainty) that the user is an adult.

In another embodiment, the characteristic platform 103 may determine to enable, to disable, or a combination thereof one or more components of the data, the one or more services, the one or more applications, one or more devices associated with the at least one user, or a combination thereof based, at least in part, on the one or more characteristics. In one scenario, the characteristic platform 103 may initiate certain limitations on the transfer of data from the user's device based on a determination that the user is a child. Limitations or requirements on data transfers may, for instance, include: (1) anonymization of certain types of data prior to being transmitted; (2) blurring of images or videos that the user attempts to transmit from his/her device; (3) size restrictions on the transmission of any content; (4) and the like. Moreover, similar limitations may additionally, or alternatively, be imposed on content that can be received by the user's device. In another scenario, particular features of a service and/or an application may be disabled for the user based on a determination that the user is a child (e.g., disabling chat features of a social networking service).

By way of example, the UE 101, the characteristic platform 103, the service platform 113, the services 115, and the content providers 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

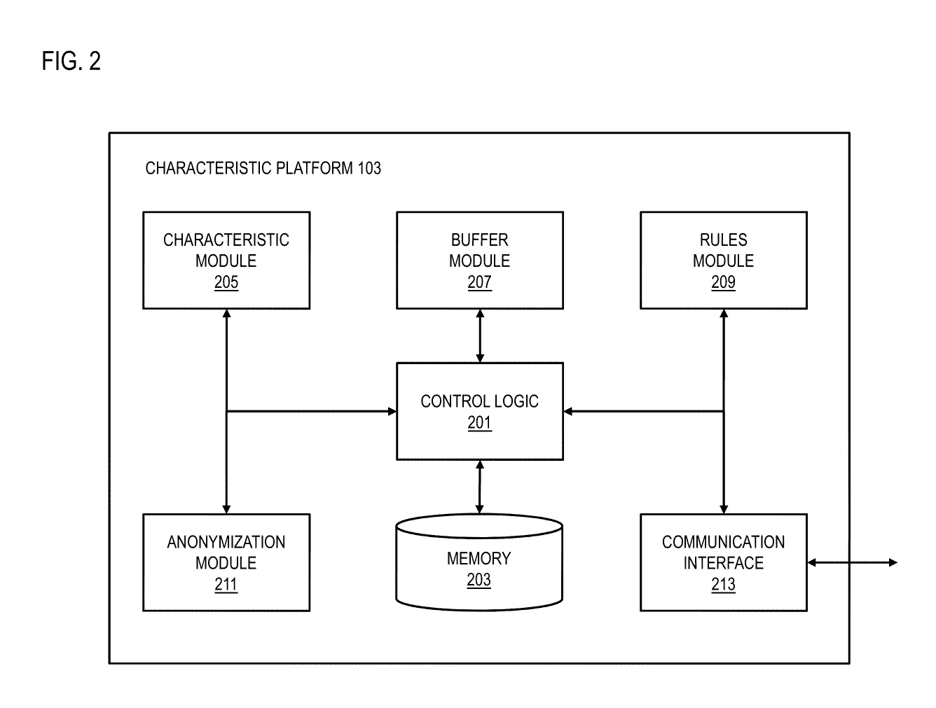

FIG. 2 is a diagram of the components of a characteristic platform, according to one embodiment. By way of example, the characteristic platform 103 includes one or more components for determining user characteristics based on use. It is contemplated that the functions of these components may be combined in one or more components or performed by other components of equivalent functionality. In this embodiment, the characteristic platform 103 includes control logic 201, memory 203, a characteristic module 205, a buffer module 207, a rules module 209, an anonymization module 211, and a communication interface 213.

The control logic 201 executes at least one algorithm for executing functions of the characteristic platform 103. For example, the control logic 201 may interact with the characteristic module 205 and the buffer module 207 to cause storage of data in a buffer, wherein the data is associated with a use of a service and/or an application along with a user of the service and/or the application. The buffer module 207 may, for instance, provide the buffer for storing the data separately (e.g., logically, physically, etc.) from other collected data (e.g., associated with other users, services, applications, etc.) and from memory that is accessible by “traditional” analytics.

The characteristic module 205 may then process the data in the buffer to determine characteristics of the user. Based on the determined characteristics, the characteristic module 205 may determine a disposition of the data in the buffer. By way of example, the disposition may include (a) a destruction of the data and/or (b) a processing of the data by the service and/or the application. In certain embodiments, the characteristic module 205 may work with the rules module 209 to determine rules associated with the characteristics of the user, which may thereafter be utilized to determine the disposition of the data in the buffer. In one scenario, for instance, usage data in the buffer may be determined to be associated with a child. As a result, any analytics performed on that usage data in the buffer may be according to all applicable rules regarding children (e.g., in compliance with COPPA).

In various embodiments, the characteristic module 205 may also enable and/or disable components of the data, the service, the application, a device associated with the user based on the determined characteristics of the user. In addition, the enabling and/or the disabling of the components may be according to the rules associated with the determined characteristics (e.g., provided by the rules module 209). As an example, a rule associated with children may require that certain limitations be imposed on content that is transmitted from, or received, by the device (e.g., images transmitted from the device are blurred, location information and other personal information are stripped from the images, etc.) if, for instance, the user is determined to be a child. As another example, a rule associated with children may require that particular features of the service and/or the application may be disabled (e.g., chat room access may be disabled) if the user is determined to be a child. In some embodiments, the control logic 201 may further interact with the anonymization module 211 to cause anonymization of a portion of the data prior to the storage of the data in the buffer, the processing of the data in the buffer, and/or the determining of the disposition of the data in the buffer.

The control logic 201 may additionally utilize the communication interface 213 to communicate with other components of the characteristic platform 103, the UEs 101 (e.g., the device, the other devices, etc.), the service platform 113, the services 115, the content providers 117, and other components of the system 100. For example, the communication interface 213 may be utilized to initiate transmission of instructions to the respective UEs 101 or other components of the system 100 to anonymized particular portions of data prior to the transfer of that data to the characteristic platform 103. The communication interface 213 may further include multiple means of communication. In one use case, the communication interface 213 may be able to communicate over short message service (SMS), multimedia messaging service (MMS), internet protocol, email, instant messaging, voice sessions (e.g., via a phone network), or other types of communication.

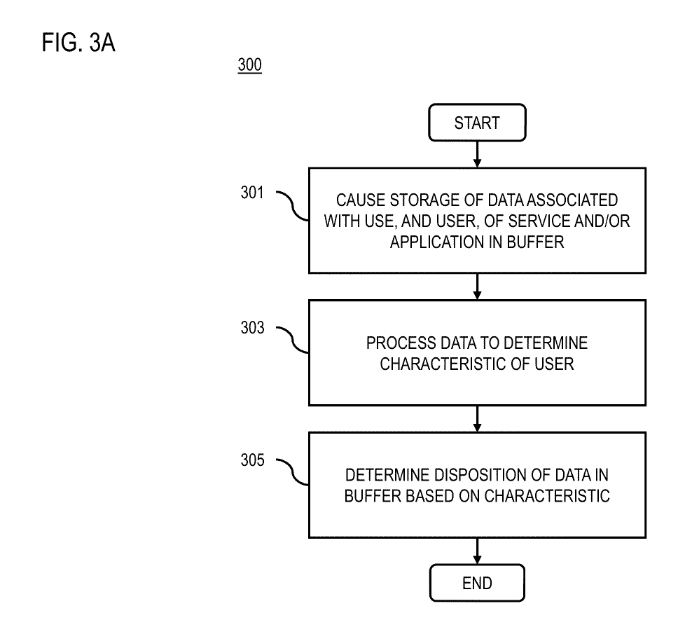

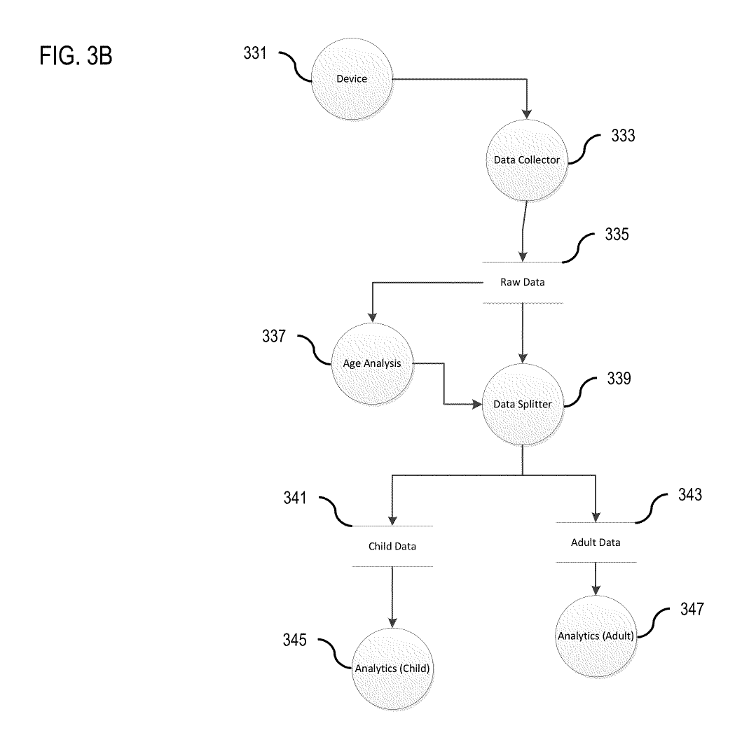

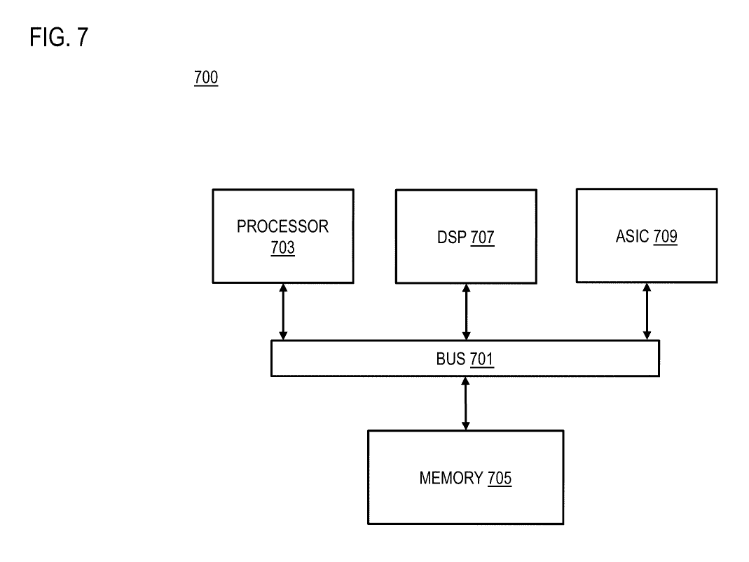

FIG. 3A is a flowchart of a process for determining user characteristics based on use, according to one embodiment. In one embodiment, the characteristic platform 103 performs the process 300 and is implemented in, for instance, a chip set including a processor and a memory as shown in FIG. 7. As such, the control logic 201 can provide means for accomplishing various parts of the process 300 as well as means for accomplishing other processes in conjunction with other components of the characteristic platform 103.

In step 301, the control logic 201 may cause, at least in part, a storage of data associated with at least one use of one or more services, one or more applications, or a combination thereof in at least one buffer, wherein the data is associated with at least one user of the one or more services, the one or more applications, or a combination thereof. As mentioned, the use data associated with the at least one user of the one or more services and/or the one or more applications may, for instance, be collected and stored in the buffer (e.g., logically and/or physically separate from memory that is accessible by “traditional” analytics). As an example, the data in the buffer may include the location of the user's device when the application and/or the service is being utilized by the user, the time associated with the use of the application and/or the service, the content being consumed by the user while using the application and/or the service, etc.

In step 303, the control logic 201 may process and/or facilitate a processing of the data to determine one or more characteristics of the at least one user. By way of example, while the data is in the buffer, information associated with the location of the use, the time of the use, and the consumed content during the use, etc., may be processed to determine the user's age range (e.g., child, mature teen, adult, etc.). Information associated with the location of the use (e.g., cell ID data, GPS data, etc.) may be compared against a body of known data of locations frequented by children (e.g., schools, youth clubs, etc.). The information associated with the time of the use may be compared against a body of known data denoting when children are more likely to be present around the location of use (e.g., children are very likely to be around school during school hours). The information associated with the consumed content may compared with a body of known data indicating the type of content that are typically consumed by various age groups (e.g., free form jazz is more likely to be listened to by adults than children, while the latest pop music is more likely to be listened to by children).

In step 305, the control logic 201 may determine at least one disposition of the data in the at least one buffer based, at least in part, on the one or more characteristics (e.g., the determination of the user's age range may be utilized to decide what to do with the data in the buffer). As indicated, the at least one disposition may include (a) a destruction of the data; (b) a processing of the data by the one or more services, the one or more applications, or a combination thereof; or (c) a combination thereof.

FIG. 3B is a diagram of a data flow based on an age associated with data, according to one embodiment. As illustrated, device 331 may, for instance, be a device or any application of the device that collects behavioral data. Behavioral data (or use data) may be collected from the device 331 by data collector 333 (e.g., a device, an application, a suite of components, etc. to which data from the device 331 is fed), which may output raw data 335. Raw data 335 may, for instance, be the collected data before the performing of age analysis 337 (e.g., which can be any collection of analysis algorithms for determining age). After age analysis 337 is performed on the raw data, the output (e.g., the raw data and the associated ages) is fed into data splitter 339. Data splitter 339 may, for instance, be a collection of processes which physically and/or logically separate the raw data 335 into child and adult portions, such as child data 341 (e.g., portions of the raw data that have been collected from minors) and adult data 343 (e.g., portions of the raw data that have been collected from adults).

Child data 341 may then be forwarded to child analytics 345 for processing. In certain embodiments, child analytics 345 may be nothing more than deletion of the child data 341 from the buffer to prevent any other analytics on the child data 341. In other embodiments, child analytics 345 may include analysis of the data that is compliance with child protection laws. Adult data 343, on the other hand, may be forwarded to adult analytics 347 for processing, which may include analysis on the data that is, for instance, in compliance with the policies (e.g., privacy policies, security policies, etc.) of the particular service and/or application. It is noted that, in some embodiments, the work of the data splitter 339 can also include delaying of the transmission of the behavioral data for analytics based on the age analysis algorithms. In one use case, for instance, the data splitter 339 may prevent any behavioral data from being released to “traditional” analytics until the age analysis algorithms have determined the characteristics (e.g., age) of the behavioral data.

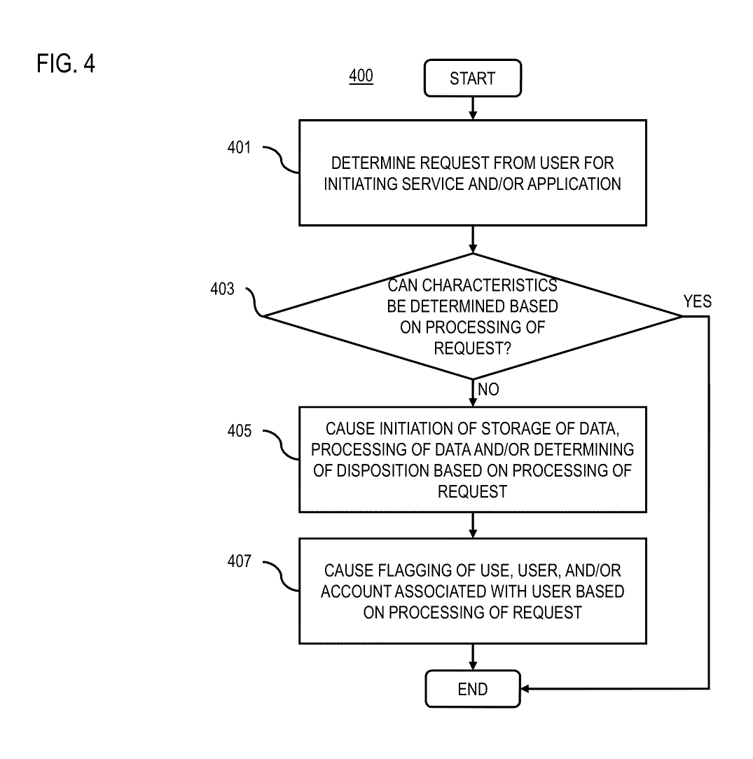

FIG. 4 is a flowchart of a process for initiating actions based on a determination that information associated with a user request does not enable accurate and/or certain determination of characteristics, according to one embodiment. In one embodiment, the characteristic platform 103 performs the process 400 and is implemented in, for instance, a chip set including a processor and a memory as shown in FIG. 7. As such, the control logic 201 can provide means for accomplishing various parts of the process 400 as well as means for accomplishing other processes in conjunction with other components of the characteristic platform 103.

In step 401, the control logic 201 may determine a request from the at least one user for initiating the one or more services, the one or more applications, or a combination thereof. By way of example, the request may be received from a device associated with the at least one user when, for instance, the at least one user registers for the one or more services, initiates the one or more applications, etc. In some embodiments, the one or more services and/or the one or more applications may enable the at least one user to provide the one or more characteristics. However, as mentioned, users may not always been willing to provide characteristics-related information, such as information about their age, or they may provide false information to hide their real characteristics.

Thus, the control logic 201 may, at step 403, process and/or facilitate a processing of the request to determine whether the request, information associated with the request, or a combination thereof enables determination of the one or more characteristics to a predetermined accuracy, a predetermined certainty, or a combination thereof. If, for instance, it is determined that the request and/or information associated with the request does not enable the determination of the one or more characteristics to the predetermined accuracy and/or the predetermined certainty, the control logic 201 may, at step 405, cause the initiation of the storage of the data, the processing of the data, the determining of the disposition, or a combination thereof. In this way, the one or more characteristics of the user may still be determined, and the disposition of the data may be determined according to those one or more characteristics. In the context of child protection, for instance, an age of the user associated with the data may be established to prevent the release of data associated with children.

In step 407, the control logic 201 may cause, at least in part, a flagging of the at least one use, the at least one user, one or more accounts associated with the least one user, or a combination thereof based, at least in part, on the processing of the request. In one scenario, an account may be flagged to denote that the account has no age information, for instance, if the account is registered without providing any age information, if the account is registered with conflicting information with respect to a user's age, etc. Collected use data associated with a user that utilizes the account to access a particular service may thus be subject to storage in the buffer for age analysis purposes based on the “no-age” flag denotation on the account. In this way, the collected use data may be inaccessible to “traditional” analytics in case the use data is associated with a child user. After the determination of the age, however, the flag denotation may be modified to reflect the age of the user. Moreover, in some embodiments, the flag denotation for the account, for the user, for the use, etc., may be continuously adjusted based on on-going age analysis of use data in the buffer.

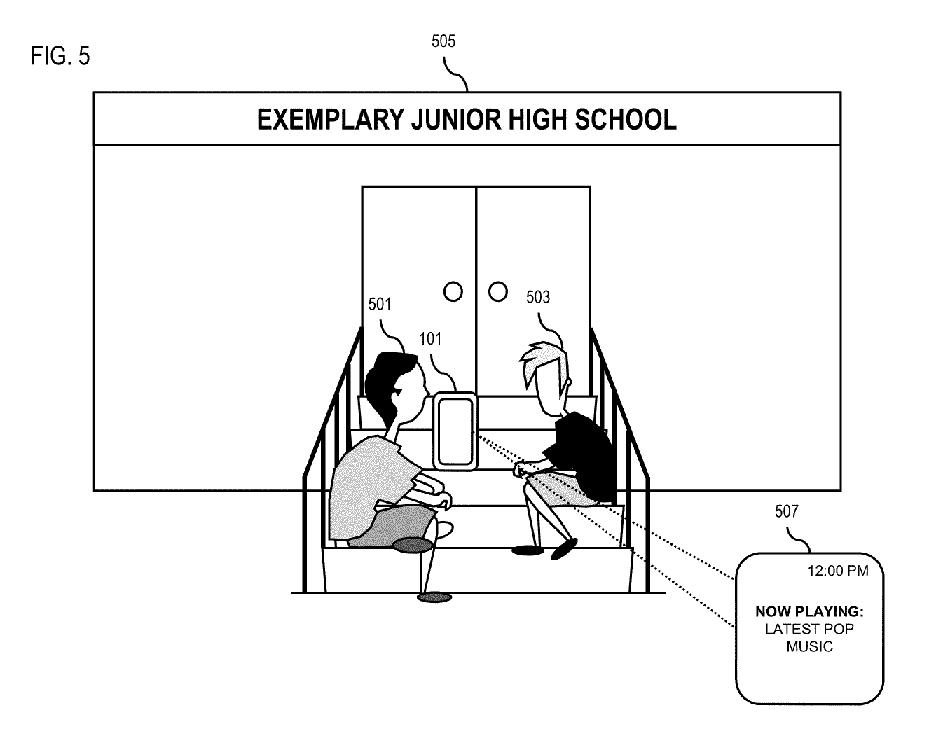

FIG. 5 is diagram of a use case for determining user characteristics, according to one embodiment. As shown, users 501 and 503 are on the front steps of building 505 (e.g., Exemplary Junior High School) listening to the latest pop music on the UE 101 (e.g., user interface 507 of the UE 101 indicates “Now Playing: Latest Pop Music” at 12:00 PM). When the users 501 and 503 initiate the music playing service associated with user interface 507, data associated with the use is collected and transmitted to the characteristic platform 103. The use data may then be stored in a buffer to determine, for instance, the ages of the users 501 and 503. As indicated, the use data may include the current location of the UE 101 that is associated with the playing of the latest pop music (e.g., Exemplary Junior High School), the time associated with the playing of the latest pop music (e.g., 12:00 PM), and the fact that the latest pop music is currently being consumed by the users 501 and 503.

During the processing of the data in the buffer, the characteristic platform 103 may, for instance, determine that children are very likely to be around Exemplary Junior High School at 12:00 PM, that 12:00 PM is generally around the time that students at the high school have lunch and recess, and that lunch and recess are typically the only periods during school hours that students are permitted to play music using their user devices. In addition, to satisfy a predetermined degree of certainty (e.g., 90%) that its user characteristic determination is accurate, it may further process other information, such as the content being consumed. In this scenario, for instance, the characteristic platform 103 may realize that the latest pop music is more likely to be listened to by children than by adults. Consequently, based on a number of factors, the characteristic platform 103 may determine that users 501 and 503 have many characteristics of children and, thus, deem users 501 and 503 to be children. Accordingly, the characteristic platform 103 may delete the use data in the buffer to prevent the data from being released for any other analytic purposes. Furthermore, the characteristic platform 103 may modify various features of the music playing service to safeguard users 501 and 503 from explicit and/or offensive content. Such modifications may, for instance, include the enabling of a censoring function of the music playing service to remove explicit and/or offensive songs from any playlist associated with the UE 101, to edit out inappropriate language from such songs, etc. In this way, the characteristic platform 103 enable manufacturers, service providers, and other concerned entities to protect children and their data without having to rely on user input of information relating to their age.

The processes described herein for determining user characteristics based on use may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

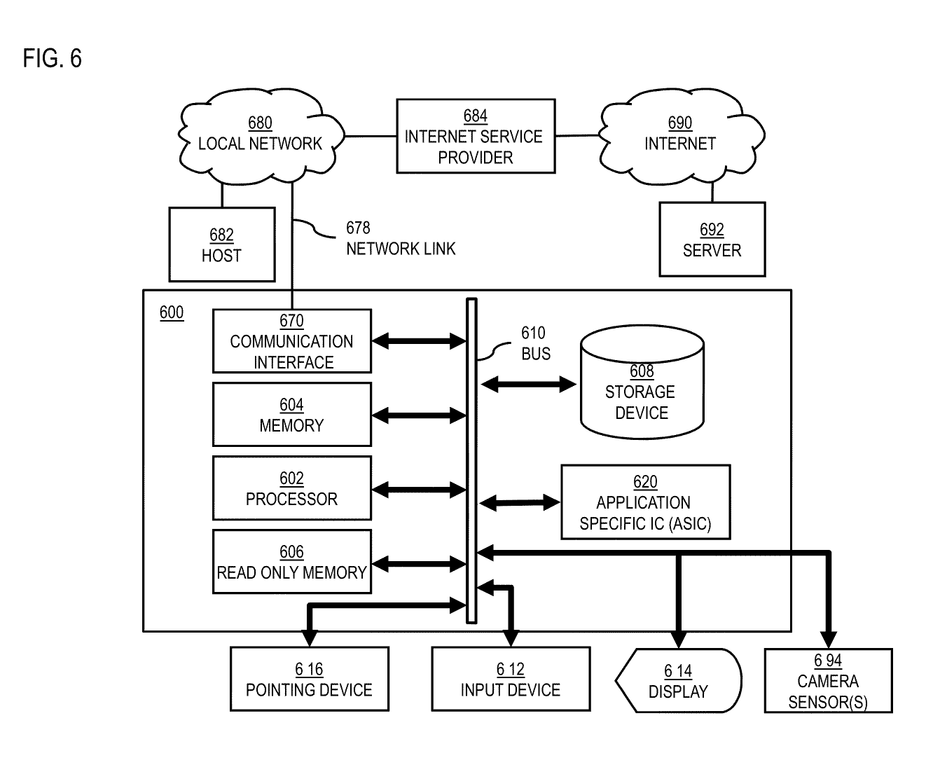

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to determine user characteristics based on use as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of determining user characteristics based on use.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to determining user characteristics based on use. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 600 also includes a memory 604 coupled to bus 610. The memory 604, such as a random access memory (RAM) or any other dynamic storage device, stores information including processor instructions for determining user characteristics based on use. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for determining user characteristics based on use, is provided to the bus 610 for use by the processor from an external input device 612, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614, and one or more camera sensors 694 for capturing, recording and causing to store one or more still and/or moving images (e.g., videos, movies, etc.) which also may comprise audio recordings. In some embodiments, for example, in embodiments in which the computer system 600 performs all functions automatically without human input, one or more of external input device 612, display device 614 and pointing device 616 may be omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for determining user characteristics based on use to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to determine user characteristics based on use as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of determining user characteristics based on use.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to determine user characteristics based on use. The memory 705 also stores the data associated with or generated by the execution of the inventive steps.

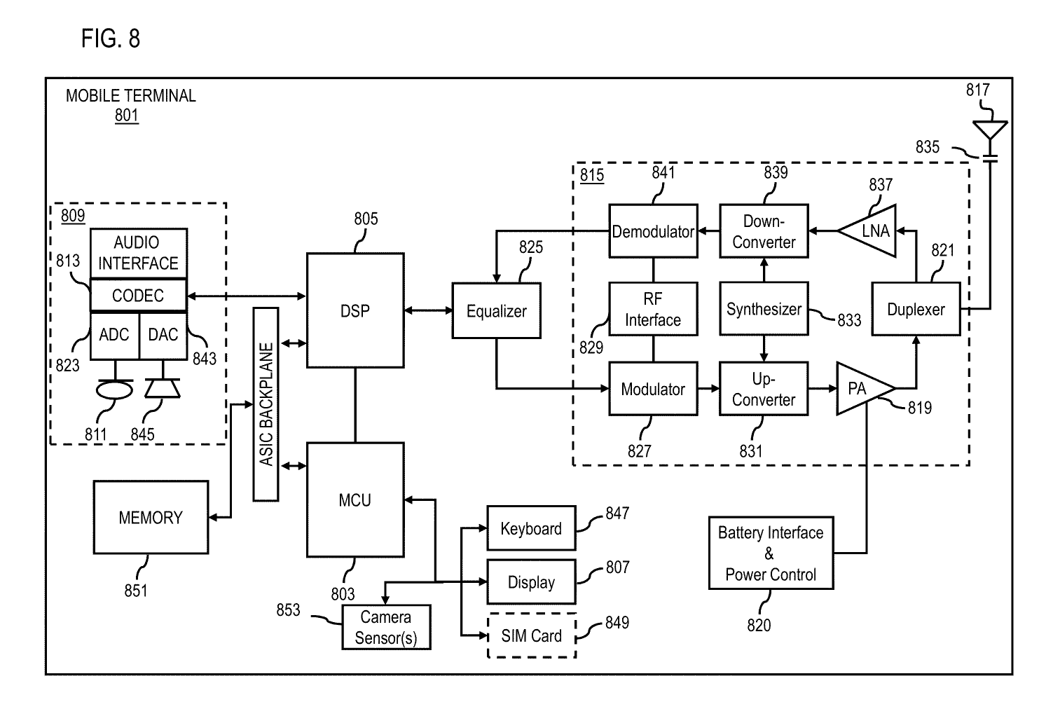

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of determining user characteristics based on use. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of determining user characteristics based on use. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to determine user characteristics based on use. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

Further, one or more camera sensors 853 may be incorporated onto the mobile station 801 wherein the one or more camera sensors may be placed at one or more locations on the mobile station. Generally, the camera sensors may be utilized to capture, record and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a storage of data associated with at least one use of one or more services, one or more applications, or a combination thereof in at least one buffer, wherein the data is associated with at least one user of the one or more services, the one or more applications, or a combination thereof;
a processing of the data to determine one or more characteristics of the at least one user; and
at least one determination of at least one disposition of the data in the at least one buffer based, at least in part, on the one or more characteristics.

2. A method of claim 1, wherein the (1) data and/or (2) information and/or (3) at least one signal are further based, at least in part, on the following:
at least one determination of a request from the at least one user for initiating the one or more services, the one or more applications, or a combination thereof;
a processing of the request to determine that the request, information associated with the request, or a combination thereof does not enable determination of the one or more characteristics to a predetermined accuracy, a predetermined certainty, or a combination thereof; and
an initiation of the storage of the data, the processing of the data, the determining of the at least one disposition, or a combination thereof based, at least in part, on the processing of the request.

3. A method of claim 2, wherein the (1) data and/or (2) information and/or (3) at least one signal are further based, at least in part, on the following:
a flagging of the at least one use, the at least one user, one or more accounts associated with the least one user, or a combination thereof based, at least in part, on the processing of the request.

4. A method of claim 1, wherein the (1) data and/or (2) information and/or (3) at least one signal are further based, at least in part, on the following:
at least one determination of a degree of certainty that the one or more characteristics are associated with the at least one user,
wherein the at least one disposition is further based, at least in part, on the degree of certainty.

5. A method of claim 1, wherein the (1) data and/or (2) information and/or (3) at least one signal are further based, at least in part, on the following:
at least one determination of one or more rules associated with the one or more characteristics,
wherein the at least one disposition is further based, at least in part, on the one or more rules.

6. A method of claim 1, wherein the (1) data and/or (2) information and/or (3) at least one signal are further based, at least in part, on the following:
at least one determination of contextual information associated with the at least one user, at least one device associated with the at least one user, or a combination thereof,
wherein the one or more characteristics are further based, at least in part, on the contextual information.

7. A method of claim 1, wherein the (1) data and/or (2) information and/or (3) at least one signal are further based, at least in part, on the following:
an anonymization of at least a portion of the data prior to the storage of the data, the processing of the data, the determining of the at least one disposition of the of the data, or a combination thereof.

8. A method of claim 1, wherein the (1) data and/or (2) information and/or (3) at least one signal are further based, at least in part, on the following:
at least one determination to enable, to disable, or a combination thereof one or more components of the data, the one or more services, the one or more applications, one or more devices associated with the at least one user, or a combination thereof based, at least in part, on the one or more characteristics.

9. A method of claim 1, wherein the at least one disposition includes, at least in part, (a) a destruction of the data; (b) a processing of the data by the one or more services, the one or more applications, or a combination thereof; or (c) a combination thereof.

10. A method of claim 1, wherein the one or more characteristics include, at least in part, an age of the at least one user.

11. An apparatus comprising:
at least one processor; and
at least one memory including computer program code for one or more programs,
the at least one memory and the computer program code configured to, with the at least one processor, cause the apparatus to perform at least the following,
cause, at least in part, a storage of data associated with at least one use of one or more services, one or more applications, or a combination thereof in at least one buffer, wherein the data is associated with at least one user of the one or more services, the one or more applications, or a combination thereof;
process and/or facilitate a processing of the data to determine one or more characteristics of the at least one user; and
determine at least one disposition of the data in the at least one buffer based, at least in part, on the one or more characteristics.

12. An apparatus of claim 11, wherein the apparatus is further caused to:
determine a request from the at least one user for initiating the one or more services, the one or more applications, or a combination thereof;
process and/or facilitate a processing of the request to determine that the request, information associated with the request, or a combination thereof does not enable determination of the one or more characteristics to a predetermined accuracy, a predetermined certainty, or a combination thereof; and
cause, at least in part, an initiation of the storage of the data, the processing of the data, the determining of the at least one disposition, or a combination thereof based, at least in part, on the processing of the request.

13. An apparatus of claim 12, wherein the apparatus is further caused to:
cause, at least in part, a flagging of the at least one use, the at least one user, one or more accounts associated with the least one user, or a combination thereof based, at least in part, on the processing of the request.

14. An apparatus of claim 11, wherein the apparatus is further caused to:
determine a degree of certainty that the one or more characteristics are associated with the at least one user,
wherein the at least one disposition is further based, at least in part, on the degree of certainty.

15. An apparatus of claim 11, wherein the apparatus is further caused to:
determine one or more rules associated with the one or more characteristics,
wherein the at least one disposition is further based, at least in part, on the one or more rules.

16. An apparatus of claim 11, wherein the apparatus is further caused to:
determine contextual information associated with the at least one user, at least one device associated with the at least one user, or a combination thereof,
wherein the one or more characteristics are further based, at least in part, on the contextual information.

17. An apparatus of claim 11, wherein the apparatus is further caused to:
cause, at least in part, an anonymization of at least a portion of the data prior to the storage of the data, the processing of the data, the determining of the at least one disposition of the of the data, or a combination thereof.

18. An apparatus of claim 11, wherein the apparatus is further caused to:
determine to enable, to disable, or a combination thereof one or more components of the data, the one or more services, the one or more applications, one or more devices associated with the at least one user, or a combination thereof based, at least in part, on the one or more characteristics.

19. An apparatus of claim 11, wherein the at least one disposition includes, at least in part, (a) a destruction of the data; (b) a processing of the data by the one or more services, the one or more applications, or a combination thereof or (c) a combination thereof.

20. An apparatus of claim 11, wherein the one or more characteristics include, at least in part, an age of the at least one user.

21-48. (canceled)
